(19) United States
(12) Patent Application Publication
(10) Pub. No.: US 2004/0095329 A1
(43) Pub. Date: May 20, 2004

(54) Computer

(76) Inventor: Barbara Sexton, Northamptonshire (GB)

Correspondence Address: Irving M Weiner, Weiner & Burt, P O Box 186, 635 N US-23, Harrisville, MI, 48740, US

(21) Appl. No.: 10/473,090

(22) PCT Filed: Mar. 26, 2002
(86) PCT No.: PCT/GB02/01179

(30) Foreign Application Priority Data
Mar. 28, 2001 (GB) 0107783.3
Jan. 22, 2002 (GB) 0201394.4

(51) Int. Cl. G09G 5/08; G09G 5/00

(52) U.S. Cl. 345/170; 345/163

(57) ABSTRACT

A computer keyboard arrangement has keys formed on one or more transparent sheets. A light distributing sheet extends beneath the keyboard sheet(s) and is illuminated by light from at least one light-emitting diode located laterally thereof. The sheets are sealed into a casing of the arrangement to prevent ingress of moisture into the casing. The keys may be illuminated by light of different colours such that respective sets of indicia are rendered visible thereon. The underside of the casing of the keyboard arrangement is shaped for conformity with a pair of human legs, to facilitate stable laptop operation.

This invention relates to a computer, and in particular to a keyboard arrangement for a computer.

Keyboards suitable for use with a personal computer, for example, comprise a plurality of keys, sufficient in number that a key may be allocated to each of the following:

(a) each of the letters of the alphabet;

(b) each of the digits “0” to “9”;

(c) certain punctuation marks, such as comma, full stop, semi-colon and inverted comma, although generally punctuation marks are provided for by keys shared with other symbols such as the digits;

(d) various non-printing characters, such as space, carriage return and tab;

(e) various functions which control the association of the keys with codes produced by the keyboard, such as the shift, control and alt keys; and

(f) various operations for use in conjunction with a computer for editing text, such as delete key and cursor movement keys.

The number of keys on such keyboards may vary from design to design but generally will not be less than 48 in number. Further, some keyboard designs may provide for one key to represent more than one particular character.

It is one object of the present invention to provide an improved computer keyboard arrangement.

In accordance with one aspect of the present invention, there is provided a keyboard arrangement for a computer, comprising at least one keyboard sheet having individual keys extending in profile forming an upper surface, wherein the sheet is transparent or translucent and indicia on the keys are opaque, a light-distributing sheet extending beneath the or each keyboard sheet, and means for directing light into the light-distributing sheet laterally thereof, thereby to illuminate the keyboard sheet to render the indicia identifiable to an operator of the keyboard.

Thus in accordance with the present invention, the keys of the keyboard sheet are illuminated from underneath, from within a casing of the arrangement, thus allowing the keyboard to be used in conditions of subdued ambient light.

The casing is advantageously provided in the form of two, or more, parts that are closed, sealed or bonded together for receiving therein the above-mentioned keyboard components.

Advantageously, the keyboard arrangement comprises a casing whereby the or each keyboard sheet and the light-distributing sheet, and any other component of the arrangement, can be substantially sealed against the ingress of moisture. Advantageously, the sealing of the keyboard arrangement is such that it is substantially splashproof, and preferably a completely waterproof arrangement is provided by means of a suitable sealant. Thus, the keyboard sheet with its profile keys extending upwardly, can form an integral sheet, thereby preventing moisture or droplets of water from penetrating between keys to the interior of the casing. The combination of a backlit waterproof keyboard thus allows usage in both dark and damp, and potentially wet, locations, such as swimming pools.

Thus, in accordance with a further aspect of the present invention, there is provided a keyboard arrangement for a computer comprising a casing and a keyboard having a plurality of keys that forms an outer surface thereof, wherein the casing and keyboard are sealed so as substantially to prevent entry of moisture to the interior of the casing.

Although the casing of the keyboard is shaped so as to provide stability when supported on a desk or other flat surface, the underside is also contoured for conformity with an operator's legs so as to allow stable operation as a laptop arrangement.

Thus, in accordance with another aspect of the present invention, there is provided a keyboard arrangement for a computer comprising a casing carrying a keyboard, wherein the underside, in operation, of the casing is shaped so as substantially to conform to a pair of human legs, whereby the arrangement is stable for laptop operation.

Preferably, the light-distributing sheet is formed of a translucent material and the light directing means comprises an illumination means having at least one light source that is mounted at the periphery of the sheet, and preferably has a plurality of light sources distributed around the periphery of the sheet, so as to direct light inwardly into the thickness thereof, thereby creating a general background light against which the opaque indicia can be read.

The light source or sources may comprise one or more light-emitting diodes, or low voltage light bulbs.

The illumination produced by the illumination means may be of any convenient colour. Alternatively, an illumination means may be provided which is capable of producing illumination in one or a plurality of colours. This may be useful in the case of a multi-functional keyboard, for example one capable of being used either with Roman alphabet text or Russian alphabet text. In such a case, having illumination means which was capable of producing, for example, red or green light, either under operator or computer control, would enable different symbols or other information to be highlighted. For example, indicia comprising Roman alphabet symbols may be coloured green to stand out against red illumination but be camouflaged against green illumination, and indicia comprising Russian alphabet symbols may be coloured red and be visible under green light illumination.

While in general the illumination means would be configured to illuminate all the keys of the keyboard, a plurality of illumination means, each capable of illuminating one or a particular set of keys may be provided. The various sets of illumination means may then be selectively turned on or off, either under operator or computer control. This would be particularly useful in applications when at various times only certain sets of the keys are functionally operational. Which keys are functionally operational may then be indicated to the user by providing that only those keys will be illuminated.

Thus, in accordance with a still further aspect of the present invention, there is provided a keyboard arrangement for a computer, comprising a casing and a keyboard having a plurality of keys, at least one source of light arranged from within the casing to illuminate the keys, and means for changing the colour of the illuminating light, whereby different respective sets of indicia are made visible on the keys.

The sets of indicia may correspond to respective keyboard layouts, which may comprise different language characters or scripts.

The light output of the light-directing means is preferably arranged to be variable in intensity, for example by means of a potentiometer.

The electrical circuitry required to operate the computer will comprise components associated with each key of the keyboard, and advantageously this circuitry is provided on a transparent sheet member that is disposed, between, on the one hand, the or each keyboard sheet, and, on the other hand, the light-directing sheet. A contact on the underside of each profiled key of the keyboard is arranged upon depression to activate an associated electrical contact of the electrical circuitry.

Preferably, the or each keyboard sheet, light-distributing sheet, electrical circuitry sheet, and the casing of the arrangement, are made of plastics material.

The casing, or housing, of the arrangement may comprise a framing member (or members) that surround the or each keyboard sheet. Advantageously, the framing member is conveniently replaceable by the supplier or by the user of the keyboard, whereby the appearance of the complete keyboard can be modified appropriately. The replacement framing members can be made available at the time of purchase of the keyboard, or subsequently. The framing members may differ in colour and/or may carry markings, for example advertising information. Thus, in accordance with another aspect of the present invention, there is provided a separable replacement framing member or members.

It is also envisaged that the keyboard arrangement may be provided with a docking port, for example at one side thereof, whereby ancillary equipment may be operatively attached thereto. The ancillary equipment may comprise, for example: a calculator; a telephone, to provide a e-mail and/or address book functions, and a mouse, or trackball.

It will be appreciated that a keyboard arrangement of the present invention may comprise some of all the various features set out above.

An illuminated and sealed keyboard, in accordance with the present invention, will now be described, by way of example, with reference to the accompanying drawings, in which:

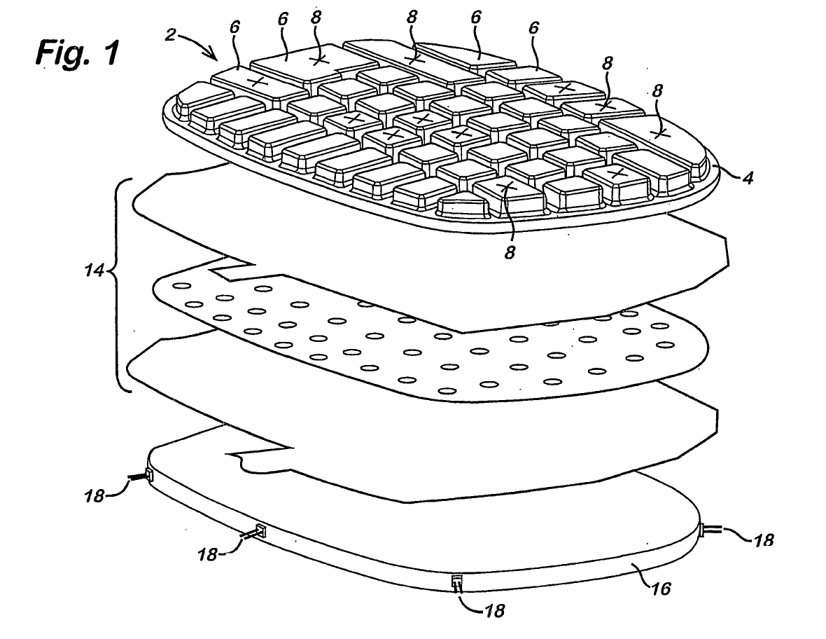

FIG. 1 is an exploded isometric view of one part of the keyboard arrangement;

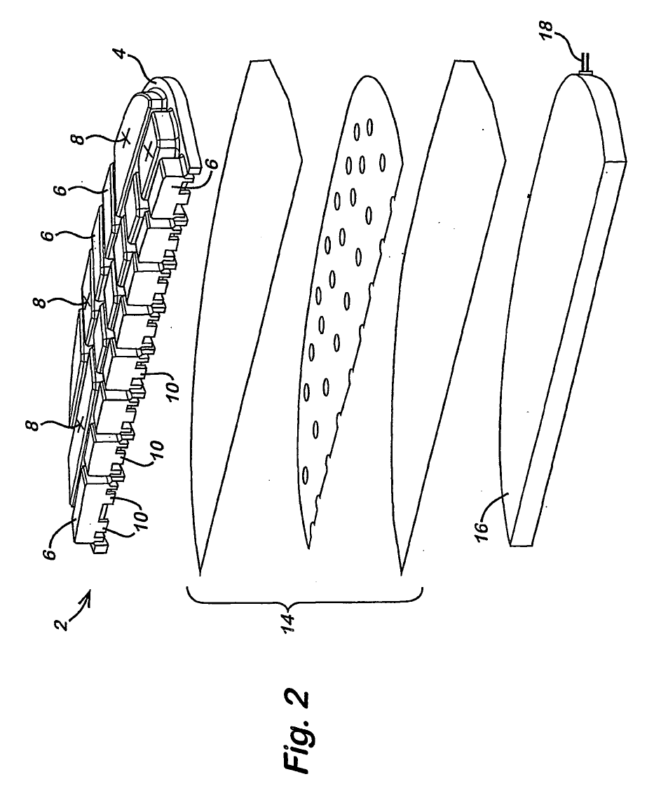

FIG. 2 is a section through FIG. 1;

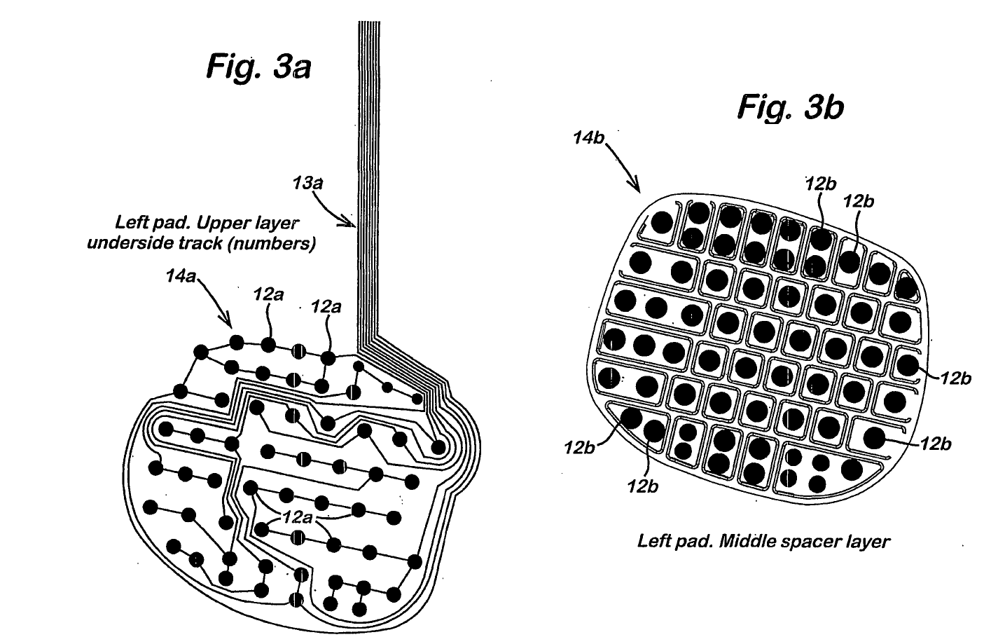

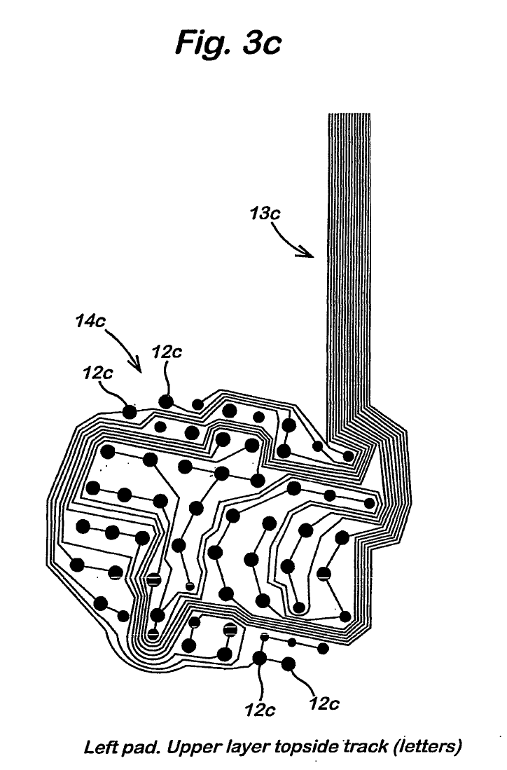

FIGS. 3a, 3b, 3c are plan views of components of FIGS. 1 and 2;

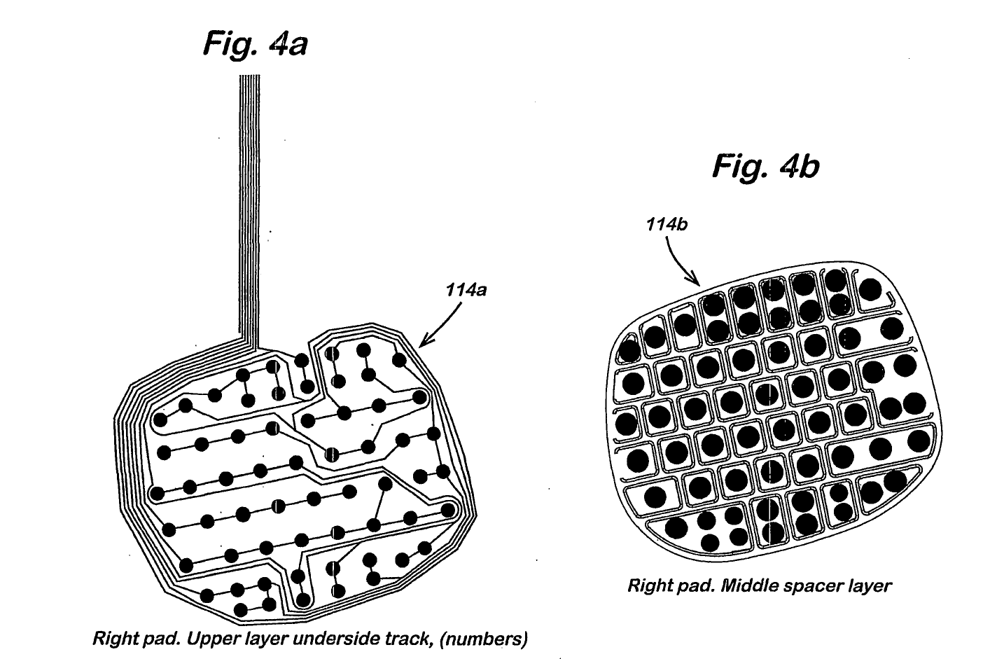

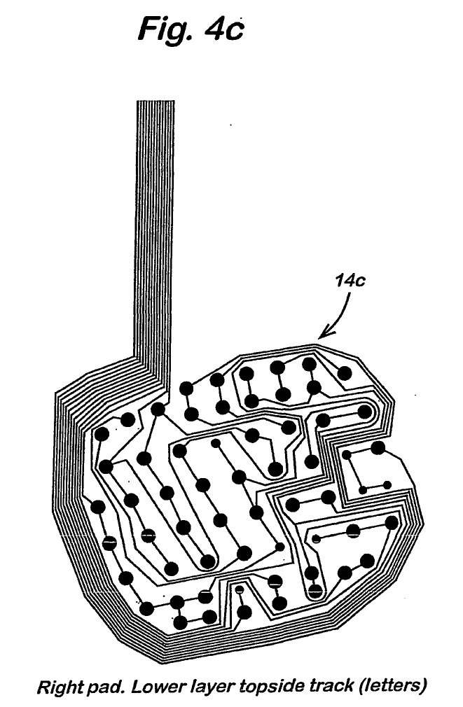

FIGS. 4a, 4b, 4c are plan views of a first complementary set of the components of FIGS. 1 and 2; and

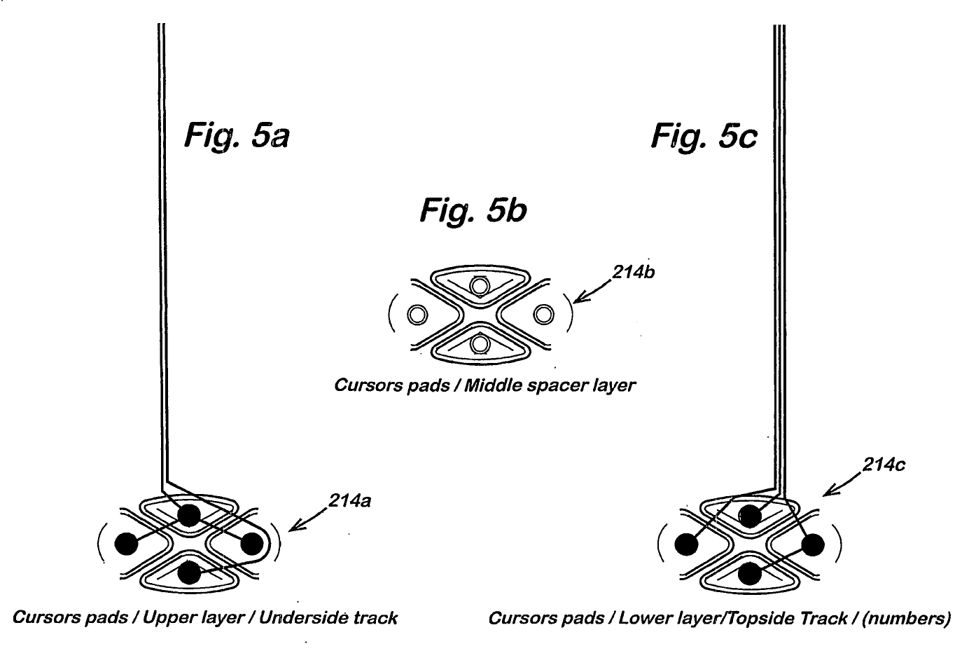

FIGS. 5a,5b,5c are plan views of a second complementary set of the components of FIGS. 1 and 2; and

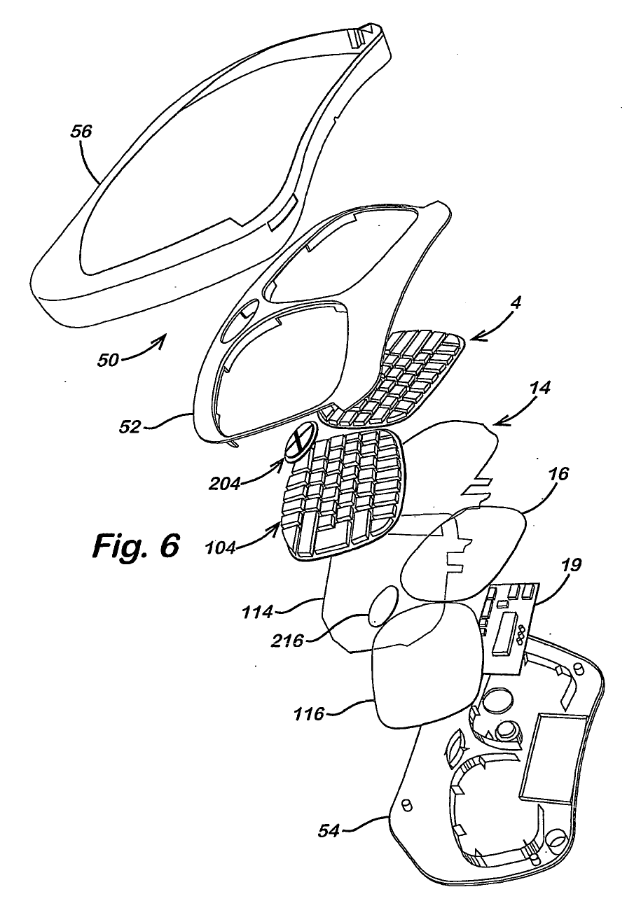

FIG. 6 is an exploded view of the complete keyboard arrangement.

Referring to FIGS. 1 and 2, a keyboard arrangement 2 comprises an upper sheet that forms a keypad 4 with a plurality of keys 6 extending upwardly in profile. Respective markings 8 are provided on the keys 6 for identification thereof, being for example, alpha-numeric or function indicia. At least one protrusion 10 beneath each key 6 is arranged to engage with a respective contact of a transparent, multi-layer, membrane 14 carrying electrical circuitry, upon depression of the appropriate key 6. Activation of the contact is detected by the operational part of the associated computer (not shown) to display a character on a screen thereof or to carry out a pre-assigned function. A substantially planar translucent perspex sheet 16 is disposed beneath the membrane 14 and the keyboard sheet 4. Six light-emitting diodes 18 (only four of which are shown) are mounted around the periphery of the sheet 16 so as to direct their light output inwardly thereof. Thus a substantially uniform illumination of the translucent sheet 16 is provided. The membrane 14 and the keyboard sheet 4 are transparent, or otherwise may be translucent, so that the light directed into the sheet 16 from the diodes 18 is seen by the operator of the keyboard when looking down on to the keys 6. In this way, the opaque markings of the indicia 8 are identifiable and readable by the keyboard operator.

As can be seen from FIGS. 1 and 2, the circuit membrane 14 consists of three layers, which are shown in detail in FIGS. 3a, b, c respectively. FIG. 3a shows the underside of the upper membrane layer 14a, with a plurality of contacts 12a arranged on eight tracks 13a. The contacts 12a are associated with respective ones of the numbers of the keypad 4. FIG. 3b shows the middle membrane layer 14b, which acts as a spacer for the upper layer 14a and the lower membrane layer 14c (FIG. 3c). The layer 14b has a plurality of holes 12b therethrough aligned with respective ones of the protrusions 10 of the keys 6 of the keyboard pad 4. FIG. 3c shows the upper surface of the membrane layer 14c, with a plurality of contacts 12c arranged on sixteen tracks 13c, the contacts 12c being associated with respective ones of the letters of the keypad 4.

In operation, depression of a key 6 of the keypad 4 urges the corresponding protrusion(s) 10 downwards so that contact is made with the associated contact(s) 12a, 12c of the layers 14a, 14c of the membrane 14, and an electrical circuit is completed along one of the tracks 13a, 13c, which lead to a circuit board 19 (FIG. 6) of the keyboard arrangement.

The combination of keypad 4, membrane 14 and translucent sheet 16 comprises one, the left hand one, of three such combinations that together make up the keyboard arrangement 2.

FIGS. 4, a, b, c show corresponding views of the three layers 114a, b, c of a membrane 114 (FIG. 6) that forms part of the right hand combination, to complete the circuitry for all the numbers and letters of the keyboard arrangement, and are constructed in a corresponding manner to the membrane layers 14a, b, c respectively.

FIGS. 5a, b, c show corresponding views of the three layers 214a, b, c of a membrane that forms part of a combination that corresponds to the four cursor direction keys of the keyboard arrangement 2, and are constructed in a corresponding manner to the membrane layers 14a, b, c respectively.

The keyboard sheets, printed membranes and light-distributing sheets, are all mounted within a casing 20 of the keyboard arrangement 2, and are mounted therein in a sealable way so that should any water or other moisture splash onto the keyboard, this will substantially be prevented from coming into contact with the internal electrical circuitry.

Although the keyboard of the computer arrangement may comprise a single keyboard sheet 4 that contains the totality of keys 6 that are conventionally found in a computer keyboard, it is preferred that the totality of keys 6 are distributed over three, keyboard sheets as described above, each of which will be sealed into the casing 20. In this embodiment, it is also envisaged that each keyboard sheet 4 will have a respective membrane 14, 114, 214 and light distributing sheets 16, 116, 216 associated therewith as shown in FIG. 6.

FIG. 6 shows the complete keyboard arrangement 2 with the three sheets 4, 104, 204 that together comprise the keyboard, that is to say the totality of keys, with sheet 204 providing the four cursor movement keys, and with the remaining keys and associated functions being distributed between the sheets 4 and 104, so as to form an ergonomically-shaped keyboard. Three membranes, only two of which 14, 114 are shown, are associated with the keyboard sheets 4, 104, 204 respectively and are mounted therebeneath. The three translucent light-distributing sheets 16, 116, 216 are located below respective ones of the three membranes respectively, for providing illumination (from light sources not shown) of the keys of the sheets 4, 104, 204. The components are enclosed within a housing 50 comprising a frame 52 with cutouts for surrounding the keyboard sheets 4, 104, 204, a supporting base 54, and a peripheral wall 56.

The frame 52, which encloses the keyboard sheets 4, 104, 204, may be made of any suitable colour and/or carry markings for aesthetic or other effect. The frame 52 may be replaceable by one of a different colour and/or one bearing different markings. It will be appreciated that the aesthetic effect of the frame 52 may be enhanced by diffusion of light therethrough from the diodes 18.

The base 54 is contoured internally to receive and positively to locate the various sheets and circuit board. Externally, the base 54 is shaped so as to provide stability for mounting the keyboard arrangement on a desk or the like. The external undersurface is also contoured so as to conform generally with a person's legs, so that the keyboard arrangement can be stabilised for use as a laptop keyboard.

The housing 50 provides a splashproof, and preferably waterproof sealing for the components located therewithin, with sealant and/or gaskets provided between the component parts thereof appropriately.

It is to be understood that certain features of the invention, which are, for clarity, described in the context of separate embodiments, may also be provided in combination in a single embodiment, Conversely, various features of the invention which are, for brevity, described in the context of a single embodiment, may also be provided separately or in any suitable subcombination.

1. A keyboard arrangement for a computer, comprising:
at least one sheet forming a keyboard having individual keys extending in profile forming an upper surface, wherein the sheet is transparent or translucent and indicia on the keys are opaque;
a light-distributing sheet extending beneath the or each keyboard sheet; and
means for directing light into the light-distributing sheet laterally thereof, thereby to illuminate the keyboard sheet to render the indicia identifiable to an operator of the keyboard.

2. An arrangement according to claim 1, wherein the totality of keys of the keyboard of the arrangement are provided on at least two, and preferably on three, of said keyboard sheets.

3. An arrangement according to claim 1, wherein:
the light-distributing sheet is formed of translucent material; and
wherein the light-directing means comprises at least one light source mounted at the periphery of the sheet so as to direct light inwardly into the thickness thereof.

4. An arrangement according to claim 2, wherein the light-distributing sheet is formed of translucent material, and wherein the light-directing means comprises at least one light source mounted at the periphery of the sheet so as to direct light inwardly into the thickness thereof.

5. An arrangement according to claim 1, wherein the light-directing means comprises at least one light-emitting diode.

6. An arrangement according to claim 2, wherein the light-directing means comprises at least one light-emitting diode.

7. An arrangement according to claim 3, wherein the light-directing means comprises at least one light-emitting diode.

8. An arrangement according to claim 4, wherein the light-directing means comprises at least one light-emitting diode.

9. An arrangement according to claim 1, wherein the intensity of the light output of the light-directing means is arranged to be variable.

10. An arrangement according to claim 1, wherein the light-directing means is arranged to direct light of different colors to the or each keyboard sheet.

11. An arrangement according to claim 10, wherein the color of the light is variable in response to selection of an appropriate function of the computer.

12. An arrangement according to claim 1, wherein:
electrical circuitry having components associated with each key of the keyboard is provided on a transparent sheet member disposed between the or each keyboard sheet and the light-directing sheet; and
wherein a contact on the underside of each profiled key of the keyboard is arranged upon depression to activate an associated electrical contact of the electrical circuitry.

13. An arrangement according to claim 1, wherein the sheets thereof are sealed in a casing of the arrangement so as substantially to prevent ingress of moisture into the casing.

14. An arrangement according to claim 1, wherein the or each keyboard sheet, light-distributing sheet, electrical circuitry sheet, and the casing of the arrangement, are made of plastics material.

15. A keyboard arrangement for a computer, comprising:
a casing and a keyboard having a plurality of keys;
at least one source of light arranged from within the casing to illuminate the keys; and
means for changing the color of the illuminating light, whereby different respective sets of indicia are made visible on the keys.

16. An arrangement according to claim 15, wherein the sets of indicia correspond to respective keyboard layouts.

17. An arrangement according to claim 16, wherein at least some of the sets of indicia correspond to different language scripts.

18. A keyboard arrangement for a computer comprising:
a casing and a keyboard having a plurality of keys that forms an outer surface thereof, wherein the casing and keyboard are sealed so as substantially to prevent entry of moisture to the interior of the casing.

19. A keyboard arrangement for a computer comprising a casing carrying a keyboard, wherein the underside, in operation, of the casing is shaped so as substantially to conform to a pair of human legs, whereby the arrangement is stable for laptop operation.

20. A keyboard arrangement according to claim 19, wherein a component of a casing thereof that surrounds a keyboard sheet is interchangeably mounted within the casing.
